(19) United States
(12) Patent Application Publication
(10) Pub. No.: US 2007/0041328 A1
(43) Pub. Date: Feb. 22, 2007

(54) Devices and methods of using link status to determine node availability

(76) Inventor: Robert John Bell IV, Hudson, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/208,136

(22) Filed: Aug. 19, 2005

(51) Int. Cl. H04J 3/14

(52) U.S. Cl. 370/248; 370/348

(57) ABSTRACT

An inter-networking device comprises a plurality of ports. Each port is operable to communicatively couple the inter-networking device to a respective ETHERNET segment. The inter-networking device further comprises ETHERNET link-integrity test functionality to determine a link status of a first port included in the plurality of ports. The inter-networking device monitors the link status of the first port. When the link status of the first port changes, the inter-networking device sends update information to at least one port included in the plurality of ports other than the first port indicating that the link status of the first port has changed.

### BACKGROUND

In a “cluster,” a group of computing devices (also referred to here as “cluster nodes”) are used to provide a particular computing resource to one or more other computing devices (also referred to here as “client nodes”). The cluster nodes are typically communicatively coupled to one another using a cluster interconnect. For example, in one type of cluster, a group of cluster nodes are used for reading and/or writing data to storage media on behalf of the client nodes. In another example, a group of cluster nodes are used to perform other data processing on behalf of the client nodes.

Clusters are often used to provide one or more resources in a scalable manner. Typically, a load balancing policy is used to distribute requests for a given resource from the various client nodes among available cluster nodes that provide that resource. One way to determine which cluster nodes are available is by the use of “heartbeat” messages. Each cluster node in the cluster periodically transmits a heartbeat message to all the other cluster nodes in the cluster. If a heartbeat message is not heard from a particular cluster node within a predetermined amount of time (also referred to here as a “heartbeat period”), that cluster node is considered to be unavailable. If a heartbeat message is received, the cluster node is considered to be available.

However, when a cluster node becomes unavailable, such a heartbeat message scheme will typically not quickly inform the other cluster nodes in the cluster of that fact. Instead, the other cluster nodes in the cluster will not learn of the unavailability of that cluster node until the current heartbeat period for that cluster node has elapsed. As a result, a request may be sent to the unavailable cluster node before the current heartbeat period has elapsed. When a request is sent to an unavailable cluster node, a response to that request will not be received from the unavailable cluster node. After a predetermined amount of time (also referred to here as the “timeout period”) has elapsed since sending the request, the request is considered to have “timed” out. In some embodiments, the request is retried (that is, resent to the unavailable cluster node) one or more times. When all such requests time out, the cluster node is considered to be unavailable and the request is directed to another cluster node in the cluster. However, the time it takes for such requests to time out increases the time it takes for such a request to ultimately be performed by another cluster node in the cluster.

Some special-purpose cluster interconnects (such as an INFINIBAND cluster interconnect) include a mechanism for quickly informing all the cluster nodes in a cluster that another cluster node is unavailable before the current heartbeat period for that cluster node has elapsed. However, lower-cost cluster interconnects implemented using Institute for Electrical and Electronics Engineers (IEEE) 802.3 networking technology (also referred to here as “ETHERNET” networking technology) typically do not include such a mechanism. The IEEE 802.3 standard defines a “link integrity” test that is implemented by an ETHERNET interface to continually verify the integrity of an ETHERNET segment (if any) that is communicatively coupled to that ETHERNET interface. An ETHERNET segment is a point-to-point ETHERNET communication link that communicatively couples two devices (also referred to here as “link partners”). Each such link partner is able to use the link integrity test to determine if that link partner is able to receive ETHERNET communications over that ETHERNET segment. However, the ETHERNET integrity link test is designed to verify the integrity of a single ETHERNET segment and is not designed to test the integrity of a communication path that comprises multiple ETHERNET segments (for example, when two nodes are communicatively coupled via an inter-networking device such as a switch, hub, repeater, bridge, route, or gateway).

### DRAWINGS

FIG. 1 is a block diagram of one embodiment of a computing system.

FIG. 2 is a block diagram of one embodiment of an inter-networking device.

FIG. 3 is a flow diagram of one embodiment of a method of monitoring a port (or other interface) of an inter-networking device.

FIG. 4 is a flow diagram of one embodiment of a method of using update information output by an inter-networking device.

Like reference numbers and designations in the various drawings indicate like elements.

### DETAILED DESCRIPTION

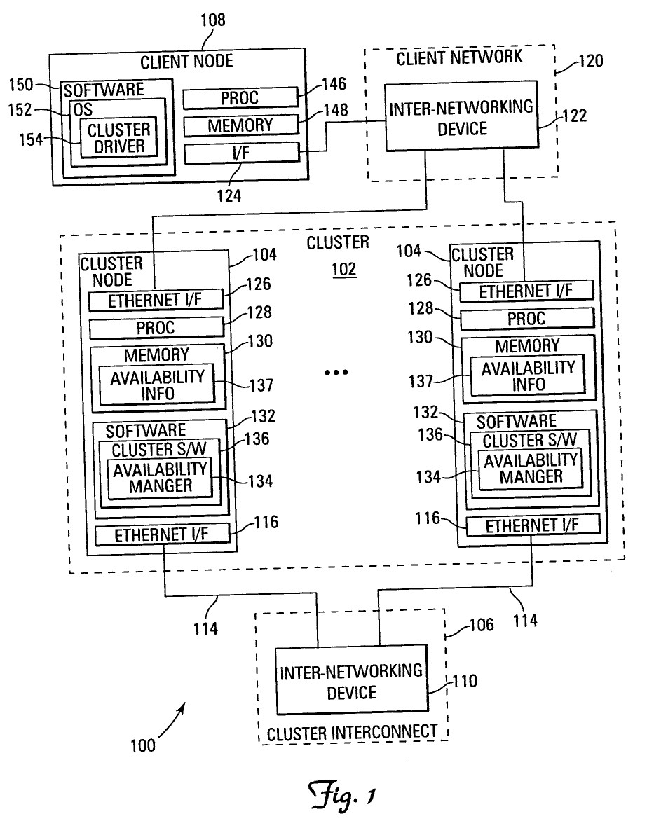

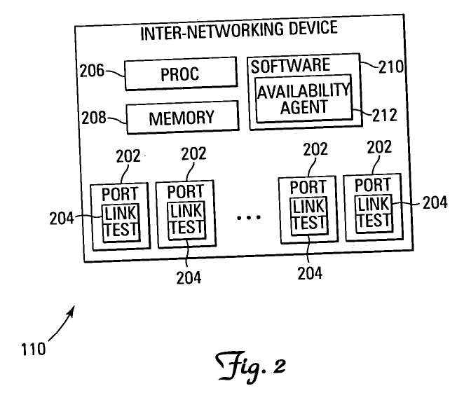

FIG. 1 is a block diagram of one embodiment of a computing system 100. In the particular embodiment shown in FIG. 1, the system 100 comprises a cluster 102. The cluster 102 comprises a plurality of cluster nodes 104 that are communicatively coupled to one another using a cluster interconnect 106. The cluster nodes 104 are used to provide one or more computing resources (for example, file storage or processing) to one or more client nodes 108 (only one of which is shown in FIG. 1). The cluster interconnect 106 comprises at least one ETHERNET inter-networking device 110 (such as a switch, hub, repeater, bridge, router, and/or gateway) that communicatively couples the cluster nodes 104 to one another over more than one ETHERNET segment. One implementation of such an embodiment is implemented using the inter-networking device 110 shown in FIG. 2.

Each cluster node 104 is communicatively coupled to the inter-networking device 110 using a respective ETHERNET segment 114. Each cluster node 104 includes an ETHERNET interface 116 that is used to send and receive data on the respective ETHERNET segment 114 that communicatively couples that cluster node 104 to the inter-networking device 110. In one implementation of such an embodiment, the ETHERNET interface 116 of each cluster node 104 supports one or more of the IEEE 802.3 family of standards, including those IEEE 802.3 standards that implement 10, 100, and 1,000 Megabit-per-second ETHERNET segments. Also, each ETHERNET segments 114 is implemented using an appropriate physical medium or media (for example, unshielded twisted-pair cables such as a Category (CAT) 5 cables).

The client nodes 108 are communicatively coupled to the cluster 102 (and the cluster nodes 104 included in the cluster 102) using a client network 120. In the embodiment shown in FIG. 1, the client network 120 comprises an ETHERNET local area network that includes at least one inter-networking device 122 such as a switch, hub, repeater, router, or gateway. Each client node 108 includes at least one ETHERNET interface 124 for communicatively coupling that client node 108 to the client network 122. Also, each of the cluster nodes 104, in the embodiment shown in FIG. 1, includes a separate ETHERNET interface 126 for communicatively coupling that cluster node 104 to the client network 122. In other embodiments, the client nodes 108 are communicatively coupled to the cluster 102 in other ways (for example, via a wide area network such as the Internet).

In the embodiment shown in FIG. 1, each client node 108 comprises at least one programmable processor 146 and memory 148. The memory 148 comprises, in one implementation of such an embodiment, any suitable form of memory now known or later developed, such as, for example, random access memory (RAM), read only memory (ROM), and/or processor registers. The programmable processor 146 executes software 150 (such as an operating system 152) that carries out at least some of the functionality described here as being performed by the client node 108. In one implementation, the operating system 152 comprises a cluster driver 154 that implements at least some of the processing described here as being performed by that client node 108. The software 150 is stored on or in a storage medium from which the software 150 is read for execution by the programmable processor 146. In one implementation of such an embodiment, at least a portion of the software 150 is stored on a local storage device (such as a local hard drive) and/or a shared storage device (such as on a file server). In other embodiments, the software 150 is stored on other types of storage media. A portion of the software 150 executed by the programmable processor 146 and/or one or more data structures used by the software 150 are stored in the memory 148 during execution of the software 150 by the programmable processor 146.

In the embodiment shown in FIG. 1, each cluster node 104 comprises at least one programmable processor 128 and memory 130. The memory 130 comprises, in one implementation of such an embodiment, any suitable form of memory now known or later developed, such as, for example, random access memory (RAM), read only memory (ROM), and/or processor registers. The programmable processor 128 executes software 132 (such as an operating system or other software) that carries out at least some of the functionality described here as being performed by the cluster node 104. In one implementation, such software 132 comprises cluster software 136 that implements at least some of the cluster-related processing described here as being performed by that cluster node 104. The software 132 is stored on or in a storage medium from which the software 132 is read for execution by the programmable processor 128. In one implementation of such an embodiment, at least a portion of the software 132 is stored on a local storage device (such as a local hard drive) and/or a shared storage device (such as on a file server). In other embodiments, the software 132 is stored on other types of storage media. A portion of the software 132 executed by the programmable processor 128 and/or one or more data structures used by the software 132 are stored in the memory 130 during execution of the software 132 by the programmable processor 128.

In the embodiment shown in FIG. 1, the cluster software 136 comprises an availability manager 134 that maintains information 137 (also referred to here as “availability information”) about the availability of other cluster nodes 104 in the cluster 102. When a client node 108 wishes to use a resource made available by the cluster 102, the software 150 executing on that client node 104 uses the cluster driver 154 to send a request to one of the cluster nodes 104 in the cluster 102 via the client network 122. The cluster node 104 to which the request is sent receives the request and determines, based on a load-balancing policy used in the cluster 102, which cluster node 104 in the cluster 102 should process the request. In the course of making this determination, the receiving cluster node 104, if necessary, uses the availability information 137 maintained at the cluster node 104 to determine which cluster nodes 104 are available.

FIG. 2 is a block diagram of one embodiment of an inter-networking device 110. The particular embodiment of the inter-networking device 110 shown in FIG. 2 is described here as being implemented for use in the system 100 of FIG. 1 as the inter-networking device 110, although other embodiments are implemented in other ways. The inter-networking device 110 comprises an ETHERNET inter-networking device such as, for example, a hub, repeater, bridge, switch, router, or gateway.

The inter-networking device 110 comprises a plurality of ports 202. Each port 202 is used to communicatively couple the inter-networking device 110 to one of the cluster nodes 104 of FIG. 1 over a respective ETHERNET segment 114. In one implementation of such an embodiment, each of the ports 202 of the inter-networking device 110 supports one or more of the IEEE 802.3 family of standards, including those IEEE 802.3 standards that implement 10, 100, and 1,000 Megabit-per-second ETHERNET segments.

Each port 202 of the inter-networking device 110 includes IEEE 802.3 link-integrity test functionality 204 for verifying the link integrity of any ETHERNET segment 114 communicatively coupled to that port 202. The link integrity of any ETHERNET segment 114 communicatively coupled to a given port 202 is also referred to here as the “link status” for that port 202. The link-integrity test functionality 204 for each port 202 outputs information (also referred to here as “link status information”) that is indicative of the link status of the port 202. When the link-integrity test functionality 204 for a particular port 202 indicates that the port 202 is able to receive ETHERNET communications on an ETHERNET segment that is communicatively coupled to that port 202, an ETHERNET link is considered to exist at or on that port 202 and the port 202 is considered to have a link status of “LINK.” When the link-integrity test functionality 204 for a particular port 202 indicates that the port 202 is not able to receive ETHERNET communications on any ETHERNET segment that is communicatively coupled to that port 202, an ETHERNET link is not considered to exist at or on that port 202 and the port 202 is considered to have a link status of “NO LINK.”

In the embodiment shown in FIG. 2, the inter-networking device 110 comprises at least one programmable processor 206 and memory 208. The memory 208 comprises, in one implementation of such an embodiment, any suitable form of memory now known or later developed, such as, for example, random access memory (RAM), read only memory (ROM), and/or processor registers. The programmable processor 206 executes software 210 that carries out at least some of the functionality described here as being performed by the inter-networking device 110.

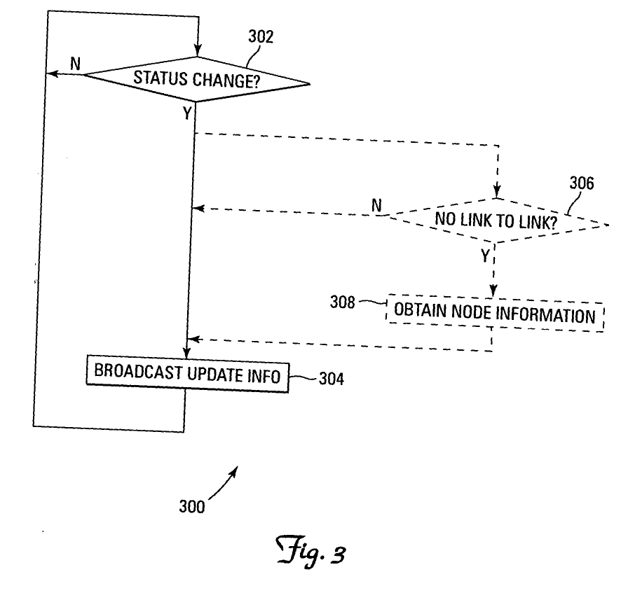

The software 210, in the embodiment shown in FIG. 2, comprises an availability agent 212 that monitors the link status of each of the ports 202 of the inter-networking device 110. In one implementation, the availability agent 212 performs the processing of method 300 of FIG. 3.

FIG. 3 is a flow diagram of one embodiment of a method 300 of monitoring a port (or other interface) of an inter-networking device. The particular embodiment of method 300 shown in FIG. 3 is described here as being implemented using the system 100 of FIG. 1 and inter-networking device 110 of FIG. 2. At least a portion of the processing described here in connection with the embodiment of method 300 shown in FIG. 3 is implemented in the availability agent 212 of the inter-networking device 110 of FIG. 2. In other embodiments, method 300 is implemented in other ways. The availability agent 212 monitors each port 202 of the inter-networking device 110 and performs the processing of method 300 for each such port 202.

Method 300 comprises determining when the link status of a given port 202 changes (block 302). The availability agent 212 monitors the link status information output by the link-integrity test functionality 204 for each port 202 to determine when the link status of that port 202 changes. When the link status of a given port 202 changes, the availability agent 212 transmits information on at least one of the other ports 202 of the inter-networking device 110 indicating that the link status of the given port 202 has changed (block 304). In one implementation of such an embodiment, the information (also referred to here as “update information”) is in the form of a SNMP message that identifies which port's link status has changed and what the current link status for that port 202 is (for example, that an ETHERNET link either exists or does not exist at the port 202). Each cluster node 104 that is attached to one of the other ports 202 of the inter-networking device 110 on which the update information was transmitted receives the update information broadcast by the availability agent 212 and updates the availability information 137 maintained by that cluster node 104 to include the current link status for the port 202 identified in the update information. In one implementation of such an embodiment, the availability agent 212 transmits the update information on all the other ports 202 of the inter-networking device 110. In another implementation, the availability agent 212 transmits the update information on less than all of the other ports 202 of the inter-networking device 110 (for example, on only those other ports 202 that are included in a predefined group of ports 202 to which such update information is to be sent).

For example, when an ETHERNET link does not exist on a given port 202 and thereafter an ETHERNET link is established on that port 202, the link-integrity test functionality 204 for that port 202 outputs link status information indicating that the link status for that port 202 has changed. The availability agent 212 detects such a link status change and broadcasts update information that identifies that port 202 and indicates that the link status of that port 202 is “LINK.” The update information is broadcast on the other ports 202 of the inter-networking device 110. When an ETHERNET link does exist on a given port 202 and thereafter that ETHERNET link is removed (for example, because the cluster node 104 that was previously coupled to that port 202 via that link has failed or is otherwise unavailable or because the respective ETHERNET segment is severed or otherwise becomes inoperable), the link-integrity test functionality 204 for that port 202 outputs link status information indicating that the link status for that port 202 has changed. The availability agent 212 detects such a link status change and broadcasts update information that identifies that port 202 and indicates that the link status of that port 202 is “NO LINK.” The update information is broadcast on the other ports 202 of the inter-networking device 110.

In an alternative embodiment (shown in FIG. 3 using dashed lines), when the link status of a given port 202 changes, the availability agent 212 checks if the link status for that port 202 has changed from a “NO LINK” status to a “LINK” status (checked in block 306). If so, the availability agent 212 obtains information about the cluster node 104 coupled to the other end of the ETHERNET segment 114 for that port 202 (block 308). For example, in one implementation of such an embodiment, the information that is obtained from the cluster node 104 (also referred to here as “node information”) comprises at least one of a media access control (MAC) address, an Internet Protocol (IP) address, and/or host name associated with that cluster node 104. In such an embodiment, the update information broadcast by the availability agent 212, in addition to identifying that port 202 and indicating that the link status of that port 202 is “LINK,” also includes at least a portion of the node information obtained by the availability agent 212. Each cluster node 104 that receives such update information uses the node information included in the update information to identify the cluster node 104 that is communicatively coupled to the identified port 202.

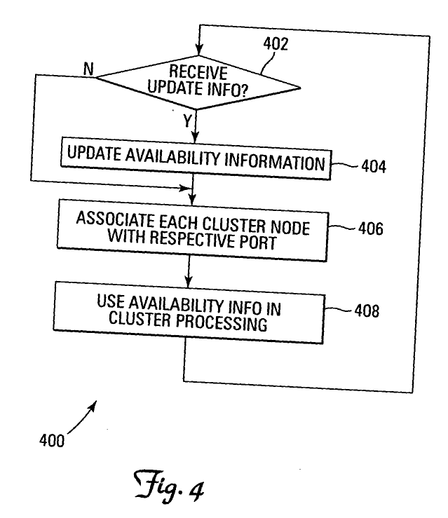

FIG. 4 is a flow diagram of one embodiment of a method 400 of using update information output by an inter-networking device. The particular embodiment of method 400 shown in FIG. 4 is described here as being implemented using a cluster node 104 included in the system 100 of FIG. 1 and for use with the inter-networking device 110 of FIG. 2. Other embodiments are implemented in other ways. At least a portion of the processing described here in connection with the embodiment of method 400 shown in FIG. 4 is implemented in, or under the control of, the availability manager 134 executing on one or more of the cluster nodes 104 of FIG. 1. In other embodiments, method 400 is implemented in other ways. For a given cluster node 104, method 400 is performed by the availability manager 134 executing on that cluster node 104 to maintain availability information 137 at that cluster node 104.

When a given cluster node 104 receives update information (block 402), the received update information is used to update the availability information 137 that is maintained at that cluster node 104 (block 404). Update information is broadcast by the inter-networking device 110 when the link status of a given port 202 of the inter-networking device 110 changes. The update information is received at the ETHERNET interface 116 of that cluster node 104 from the ETHERNET segment 114 that couples the cluster node 104 to the inter-networking device 110. The received update information identifies the port 202 that has had a link status change (also referred to here as the “identified port” 202) and identifies the current link status of that port 202. The availability manager 134 updates the availability information 137 for the identified port 202 to indicate that the identified port 202 has the link status identified in the update information.

The availability manager 134 of a given cluster node 104 also associates each cluster node 104 in the cluster 102 with a particular port 202 of the inter-networking device 110 (block 406). In an embodiment where the inter-networking device 110 includes node information in the update information when the link status of a given port 202 changes to a “LINK” status, the availability manager 134 of a given node 104 uses at least a portion of the node information included in the update information received at a given node 104 to identify the cluster node 104 that is coupled to the identified port 202 over a respective ETHERNET segment 114. In other embodiments, the availability manager 134 associates each cluster node 104 in the cluster 102 with a particular port 202 of the inter-networking device 110 in other ways. For example, in one such embodiment, the availability manager 134 associates each cluster node 104 in the cluster 102 with a particular port 202 of the inter-networking device 110 based on a priori knowledge of which cluster node 104 is coupled to which port 202 of the inter-networking device 110.

The availability manager 134, when performing cluster processing for a given cluster node 104, uses the availability information 137 to determine the availability of other cluster nodes 104 in the cluster 102 (block 408). For example, in one implementation of such an embodiment, the cluster software 136 implements a load-balancing policy that determines when a particular operation should be performed by a cluster node 104 other than the current cluster node 104 and which other cluster node 104 should perform the operation. The availability manager 134 uses the availability information 137 to determine which of the other cluster nodes 104 are available via the inter-networking device 110 (that is, which of the other cluster nodes 104 the cluster software 136 is able to communicate with via the inter-networking device 110).

The processing of methods 300 and 400 is shown in FIGS. 3 and 4, respectively, as occurring in a particular order for the purposes of illustration, and it is to be understood that such processing need not occur in the order shown in FIGS. 3 and 4.

In one implementation of the embodiment shown in FIGS. 1 through 4, the availability agent 212 is implemented as a simple network management protocol (SNMP) agent and the availability manager 134 is implemented as an SNMP manager. In such an implementation, the availability information 137 maintained by each cluster node 104 is implemented as an SNMP management information base (MIB). The update information is implemented using an SNMP trap that is sent by the availability agent 212 when the link status for a given port 202 changes. The SNMP trap identifies the port 202 whose link status has changed and the current link status of that port 202. In other embodiments and implementations, the availability agent 212, the availability manger 134, and/or the availability information 137 are implemented in other ways.

By sending such update information when the link status of a port 202 of the inter-networking device 110 changes, the cluster nodes 104 of the cluster 102 are informed of such change without requiring a heartbeat period to elapse or one or more requests (or other messages) to time out. When the link status indicates that the a given cluster node 104 is not available, the other cluster nodes 104 in the cluster 102 are able to avoid sending requests to the unavailable cluster node 104, which avoids the delays associated with waiting for such requests to timeout.

Embodiments of the inter-networking device 110 of FIG. 2 can be used in other applications (for example, in networks other than cluster interconnects). For example, in one alternative embodiment of the system 100 of FIG. 1, the inter-networking device 122 included in the client network 120 is implemented using an embodiment of the inter-networking device 110 of FIG. 2.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. An inter-networking device comprising:
a plurality of ports, wherein each port is operable to communicatively couple the inter-networking device to a respective ETHERNET segment; and
ETHERNET link-integrity test functionality to determine a link status of a first port included in the plurality of ports;
wherein the inter-networking device monitors the link status of the first port;
wherein when the link status of the first port changes, the inter-networking device sends update information to at least one port included in the plurality of ports other than the first port indicating that the link status of the first port has changed.

2. The inter-networking device of claim 1, wherein when the link status of the first port changes, if a respective ETHERNET link exists on the first port, the inter-networking device obtains node information about a node that is communicatively coupled to the first port.

3. The inter-networking device of claim 2, wherein the update information comprises at least a portion of the node information.

4. The inter-networking device of claim 1, further comprising software that is operable to cause the inter-networking device to:
monitor the link status of the first port; and
send the update information on at least one port included in the plurality of ports other than the first port indicating that the link status of the first port has changed when the link status of the first port changes.

5. The inter-networking device of claim 1, wherein the inter-networking device comprises at least one of a hub, repeater, switch, bridge, router, and gateway.

6. The inter-networking device of claim 4, wherein the software is implemented using a simple network management protocol.

7. A system comprising:
a plurality of nodes;
an inter-networking device comprising a plurality of ports, wherein each port is operable to communicatively couple the inter-networking device to a respective ETHERNET segment, wherein each ETHERNET segment is coupled to a respective one of the plurality of nodes;
wherein the inter-networking device comprises ETHERNET link-integrity test functionality to determine a link status of a first port included in the plurality of ports;
wherein the inter-networking device monitors the link status of the first port;
wherein when the link status of the first port changes, the inter-networking device sends update information on at least one of the plurality of ports other than the first port indicating that the link status of the first port has changed.

8. The system of claim 7, wherein at least one of the plurality of nodes maintains availability information indicative of the link status of at least a portion of the plurality of ports of the inter-networking device.

9. The system of claim 8, wherein the availability information comprises information about at least one of the plurality nodes.

10. The system of claim 8, wherein the plurality of nodes comprises a plurality of cluster nodes that are communicatively coupled to on another using a cluster interconnect that comprises the inter-networking device.

11. The cluster of claim 10, wherein each of the plurality of cluster nodes uses the availability information in load-balancing processing performed by the respective cluster node.

12. A method comprising:
monitoring an ETHERNET link status of a first ETHERNET port included in a plurality of ETHERNET ports of an inter-networking device; and
when the link status of the first ETHERNET port changes, sending update information on at least one of the plurality of ETHERNET ports other than the first ETHERNET port;
wherein the update information is used to determine if a node coupled to the first port of the inter-networking device is available via the inter-networking device.

13. The method of claim 12, further comprising:
when the link status of the first ETHERNET port changes and the link status indicates that an ETHERNET link exists on the first port:
obtaining node information about a node coupled to the first port via the ETHERNET link; and
including at least a portion of the node information in the update information; and
wherein the node information included in the update information is used to identify the node.

14. A node comprising:
an ETHERNET interface to communicatively couple the node to an ETHERNET segment that is coupled to one of a plurality of ports of an ETHERNET inter-networking device;
software operable to cause the node to:
maintain availability information that is indicative of the link status of at least one of the plurality of ports of the ETHERNET inter-networking device, wherein the availability information is updated using update information sent by the ETHERNET inter-networking device when the link status of at least one of the plurality of ETHERNET ports changes; and
use the availability information to determine if another node coupled to the ETHERNET inter-networking device is available via the ETHERNET inter-networking device.

15. The node of claim 14, wherein the software comprises cluster software, wherein the cluster software uses the availability information in load-balancing processing performed by the cluster software.

16. The node of claim 15, wherein the cluster software is operable to cause the node to provide file storage resources for other nodes.

17. The node of claim 14, wherein the ETHERNET inter-networking device is a part of a cluster interconnect.

18. A method comprising:
maintaining availability information at a node, wherein the availability information is indicative of the link status of at least one of a plurality of ETHERNET ports of an ETHERNET inter-networking device to which the node is communicatively coupled;
updating the availability information using update information sent by the ETHERNET inter-networking device when the link status of at least one of the plurality of ETHERNET ports changes;
associating at least one other node with a respective one of the plurality of ETHERNET ports of the ETHERNET inter-networking device; and
using the availability information to determine if another node coupled to the ETHERNET inter-networking device is available via the ETHERNET inter-networking device.

19. The method of claim 18, wherein the update information comprises node information, wherein the node information included in the update information sent by the ETHERNET inter-networking device is used to associate the at least one other node with the respective one of the plurality of ETHERNET ports of the ETHERNET inter-networking device.

20. The method of claim 18, wherein the link status of each of the plurality of ETHERNET ports of the ETHERNET inter-networking device is determined using an ETHERNET link-integrity test.
